(19) United States
(12) Patent Application Publication
(10) Pub. No.: US 2009/0251295 A1
(43) Pub. Date: Oct. 8, 2009

(54) Method and Apparatus for Tracking and Monitoring Containers

(75) Inventors: John P. Norair, Palo Alto, CA (US); Reiner G. Mim, Cupertino, CA (US); Patrick E. Burns, Burlingame, CA (US)

Correspondence Address: HAYNES AND BOONE, LLP;IP Section, 2323 Victory Avenue, Suite 700, Dallas, TX, 75219, US

(73) Assignee: Savi Technology, Inc., Mountain View, CA (US)

(21) Appl. No.: 12/399,724

(22) Filed: Mar. 6, 2009

Related U.S. Application Data
(60) Provisional application No. 61/034,764, filed on Mar. 7, 2008.

(51) Int. Cl. H04Q 5/22

(52) U.S. Cl. 340/10.51

(57) ABSTRACT

A tag responds to receipt of a short-range wireless signal by altering the operation of a transmitter that transmits long-range wireless signals containing a unique tag identification, and conforming to a satellite or cellular network communication protocol. According to a different aspect, a tag responds to receipt of a short-range wireless signal by altering operation of a receiver that receives long-range wireless signals containing positioning information, the tag determining location information from the positioning information. According to another aspect, a tag responds to receipt of a short-range wireless signal by altering operation of a sensor section having a sensor responsive to a condition.

This application claims the priority under 35 U.S.C. §119 of provisional application No. 61/034,764 filed Mar. 7, 2008, the disclosure of which is hereby incorporated herein by reference.

### FIELD OF THE INVENTION

This invention relates in general to techniques for tracking and monitoring and, more particularly, to techniques for tracking and monitoring assets such as shipping containers.

### BACKGROUND

A variety of different products are transported in shipping containers. Products are packed into a container by a shipper, and then the container doors are closed and secured with some type of lock. The locked container is then transported to a destination, where a recipient removes the lock and unloads the container.

It is often advantageous to the shipper if some form of monitoring can be carried out while the container is being transported. As one example, the cargo in the container may be relatively valuable products such as computers or other electronic devices, and thieves may attempt to break into the container to steal these products while the container is in transport. As a different example, the cargo in the container may include products such as fresh fruit, for which it is advantageous to continuously monitor temperature, humidity and/or other environmental conditions, in order to avoid or minimize spoilage. Another consideration is that it may be beneficial to the shipper and/or the recipient to be able to accurately track the current location of the container as it travels from the shipper to the recipient.

It is not cost-feasible to have a person watch a container at all times in order to provide security and/or monitoring. Accordingly, electronic systems have previously been developed to provide a degree of automated security and/or monitoring. For example, one existing approach is to attach a radio frequency identification (RFID) tag to a container. The tag then provides monitoring as to both security and environmental conditions, and can send wireless signals that contain status information, including warnings about alarm conditions. Pre-existing systems of this type have been generally adequate for their intended purposes, but they have not been satisfactory in all respects. As one example, tags are typically battery operated, and there is always a need to find new ways to minimize power consumption, while maximizing the “visibility” of the tag to a central system, and minimizing service costs.

### BRIEF DESCRIPTION OF THE DRAWINGS

A better understanding of the present invention will be realized from the detailed description that follows, taken in conjunction with the accompanying drawings, in which:

FIG. 1 is a diagrammatic view of a tracking and monitoring system that embodies aspects of the present invention.

FIG. 2 is a diagrammatic perspective view of a shipping container and a radio frequency identification tag that are components of the system of FIG. 1.

FIG. 3 is diagrammatic top view of the tag of FIG. 2, and also has broken lines showing portions of two doors of the container of FIG. 2.

FIG. 4 is a diagrammatic view of a data format used in signals transmitted by a signpost that is a component of the system of FIG. 1.

FIG. 5 is a block diagram of circuitry within the tag of FIG. 2.

FIG. 6 is a diagrammatic view of a data format used in signals that can be transmitted by the tag of FIG. 2, for example to a satellite that is a component of the system of FIG. 1.

FIG. 7 is a diagrammatic sectional top view of a warehouse through which the container and tag of FIG. 2 may travel.

### DETAILED DESCRIPTION

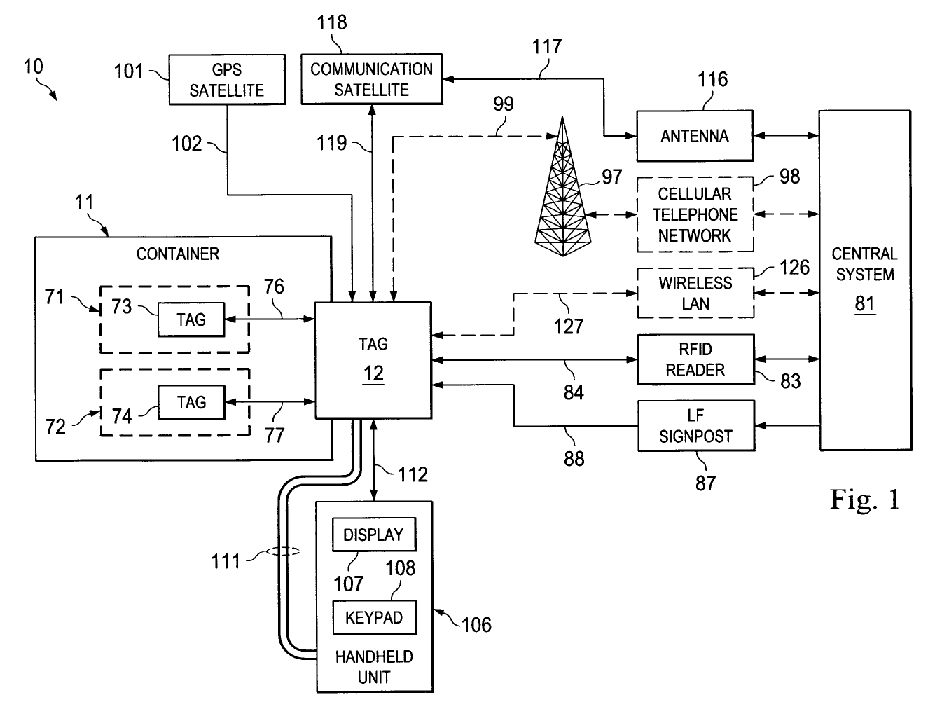

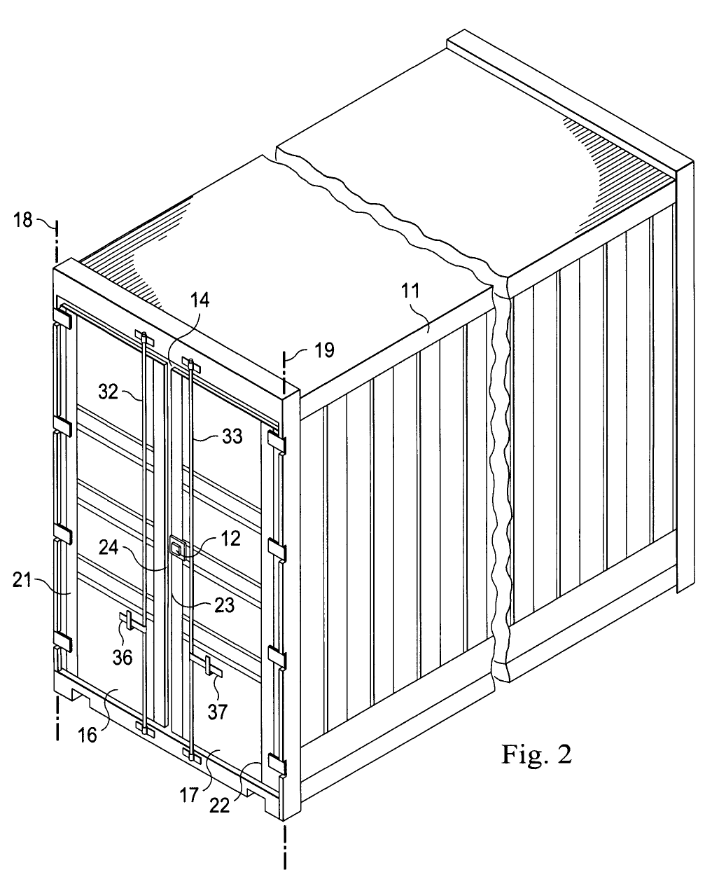

FIG. 1 is a diagrammatic view of a tracking and monitoring system 10 that embodies aspects of the present invention. The system 10 includes a container 11 having a tag 12 supported thereon. FIG. 2 is a diagrammatic perspective view of the container 11 and tag 12. The container 11 is a conventional shipping container of a well-known type, and in particular happens to comply with an industry-standard specification known as an ISO 668:1995 (E) Series 1 freight container. The majority of containers that are currently in commercial use conform to this ISO standard. However, this particular type of container is shown only by way of example. The present invention is not limited to this particular type of container, or to containers in general. For example, the tag 12 could alternatively be mounted on some type of asset other than a container.

The container 11 is made almost entirely of steel or aluminum, except that a not-illustrated floor within the container may be made of either wood or metal. The container 11 has at one end a large opening 14 with an approximately square shape. The container has hinges that support two rectangular doors 16 and 17 for pivotal movement about respective spaced vertical axes 18 and 19. The axes 18 and 19 are located near respective side edges of the opening 14. The doors 16 and 17 are each shown in a closed position in FIG. 2, and can each pivot 90° to 270° outwardly from the closed position to an open position, which is not shown in the drawings.

The doors 16 and 17 each have a respective vertical outer edge 21 or 22, which is disposed adjacent the associated pivot axis 18 or 19. In addition, the doors 16 and 17 each have a respective vertical inner edge 23 or 24. When the doors 16 and 17 are in the closed position of FIG. 2, the inner edges 23 and 24 are adjacent, with a small gap between them. In order to secure the doors 16 and 17 in their closed positions, the door 16 has a vertical rod 32 rotatably supported thereon, and the door 17 has a vertical rod 33 rotatably supported thereon. Each of the rods 32 and 33 has a respective handle 36 or 37 thereon. The handles 36 and 37 can be used to manually rotate the rods 32 and 33 between locked and released positions. In the locked position, each handle can engage a retention bracket mounted on the associated door, and the retention bracket maintains the handle and rod in the locked position. As each rod is pivoted between its locked and released positions, locking projections at each end of the rod can move into or out of engagement with locking brackets or locking recesses provided on the container 11.

When the container 11 has been packed with items or products that are to be shipped, various considerations come into play. As a first example, there are situations in which it is desirable to be able to monitor environmental conditions within the container. For example, products such as fresh fruit may keep better if environmental conditions within the container 11 remain within certain acceptable limits. Thus, it may be desirable to monitor relevant environmental conditions such as temperature or humidity. As a second example, after the doors 16 and 17 have been closed and secured at the point of shipment, it may be desirable to have some form of security and monitoring in order to verify that the doors are not opened again until the container arrives at its destination. For example, while the container is in transit, thieves may attempt to break into the container 11 in order to steal valuable cargo therein, such as computers or other electronic devices. As a third example, the shipper may wish to have accurate information about the current location of the container as it progresses along its journey from the shipper to the recipient. The tracking and monitoring system 10 of FIG. 1 addresses these types of concerns.

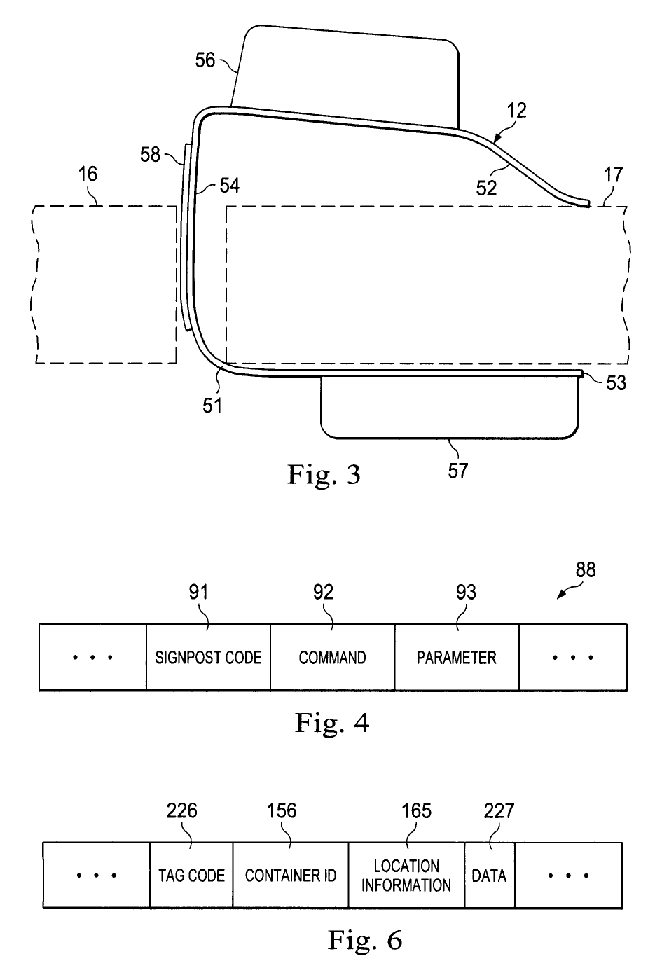

FIG. 3 is diagrammatic top view of the tag 12 of FIGS. 1 and 2, and also has broken lines showing portions of the two container doors 16 and 17. The tag 12 includes a resiliently-flexible metal support clip 51. The support clip 51 is approximately C-shaped, and grips around an edge portion of the container door 17, in order to removably support the tag 12 on the door 17. The clip 51 includes two spaced legs 52 and 53, and also a bight 54 that extends between the legs at one end of the legs. An interior module 56 is fixedly secured to the outer side of the leg 52, and an exterior module 57 is fixedly secured to the outer side of the leg 53.

The modules 56 and 57 contain most but not all of the circuitry of the tag 12. The circuitry is discussed in more detail later, but one part of the circuitry is a flat, flexible door sensor 58 that is fixedly secured to the outer side of the bight 54 of the clip 51. In the disclosed embodiment, the door sensor 58 is a capacitive proximity sensor that is responsive to the presence or absence of the metal door 16 in the vicinity of the sensor 58. It is not necessary for the metal door 16 to physically touch the door sensor 58.

Although the door sensor 58 is a capacitive proximity sensor, it would alternatively be possible to use some other type of sensor, such as a pressure sensor that is engaged by door 16, and actuated by physical pressure exerted on it by the door 16. The interior module 56, door sensor 58 and exterior module 57 are electrically coupled by a ribbon cable that is not visible in the drawings. The ribbon cable extends along the outer side of the clip 51, from the interior module 56 to the door sensor 58, and then on to the exterior module 57. The physical configuration of the tag 12 shown in FIG. 3 is provided by way of example, and the tag could alternatively have some other configuration.

Referring again to FIG. 1, when the container 11 is in operational use, it will typically contain a plurality of products or other items that are being shipped. Two such items are indicated diagrammatically at 71 and 72 in FIG. 1. These two items may each have a radio frequency identification (RFID) tag 73 or 74 supported thereon. In the disclosed embodiment, the tags 73 and 74 are conventional and commercially-available components, and are therefore not described here in detail. In the interior of the container 11, the tag 12 can emulate a device of the type commonly known as an RFID reader. In particular, as indicated diagrammatically at 76 and 77, the tag 12 can transmit and receive ultra high frequency (UHF) wireless signals 76 and 77. In the disclosed embodiment, the UHF signals 76 and 77 conform to a conventional RFID communication protocol, but they could alternatively conform to some other protocol. In response to signals 76 and 77 received from the tag 12, the tags 73 and 74 can transmit UHF signals 76 and 77 back to the tag 12. In the disclosed embodiment, the UHF transmissions 76 and 77 occur in each direction at a frequency of 433.92 MHz, but they could alternatively occur at some other suitable frequency.

The system 10 includes a computer-based central system 81 that communicates with the tag 12 in order to facilitate tracking and monitoring of the container 11. As one aspect of this, the central system 81 is coupled to a stationary RFID reader 83. A typical system might include a plurality of readers 83 but, for clarity, only one reader 83 is shown in FIG. 1. In the disclosed embodiment, the reader 83 is a conventional device, and is therefore not illustrated and described here in detail. The reader 83 can transmit and receive UHF wireless signals 84, in order to communicate with the tag 12. These UHF communications are carried out at the above-mentioned frequency of 433.92 MHz, but they could alternatively be carried out at some other suitable frequency. In the disclosed embodiment, the signals 84 conform to an existing RFID communication protocol known as the EchoPoint 2.2 protocol, but they could alternatively conform to some other communication protocol. Signals 84 transmitted from the reader 83 to the tag 12 include a reader identification code that uniquely identifies the particular reader 83. The disclosed tag 12 happens to include a UHF transmitter that can be used to transmit signals at 84 to the reader 83, but it would alternatively be possible for the tag 12 to have only a UHF receiver, and no UHF transmitter.

The system 10 also includes a stationary signpost 87 of a known type, and the signpost 87 is electrically coupled to the central system 81. A typical system would include a plurality of the signposts 87 but, for clarity, only one signpost 87 is shown in FIG. 1. The signpost 87 transmits wireless signpost signals 88. In the disclosed embodiment, the signpost signals 88 conform to a known communication protocol, and are near field signals with a relatively high roll-off and a relatively short transmission range, for example about four to twelve feet. In the disclosed embodiment, the signpost signals 88 are relatively low frequency (LF) signals that have a frequency of 122.88 KHz. However, it would alternatively be possible to use some other suitable frequency.

FIG. 4 is a diagrammatic view of a data format used for the signpost signals 88. As mentioned above, the signpost signals 88 conform to a known protocol, and the entire data format of the signpost signal 88 is therefore not illustrated and described here in detail. Only certain relevant portions of the signpost signal 88 are illustrated and described here. More specifically, each signpost signal 88 includes an identification code 91 that is called a signpost code. The signpost code 91 uniquely identifies the particular signpost 87 that transmitted the signpost signal 88. Thus, if the tag 12 is receiving wireless signals 88 from the signpost 87, the signpost code 91 embedded within those signals will uniquely identify the particular signpost that transmitted the signals. This in turn will give a coarse indication of the current location of the tag 12 because, for the tag to have received signpost signals from a given signpost, the tag must be within a radius of about 12 feet from that signpost.

The signpost signal 88 also includes a field that contains a command 92. The command 92 is a command sent by the central system 81 to the tag 12, and can affect the operation of the tag 12. Some types of commands 92 do not require any associated parameter, but other types of commands do require a parameter. As to the types of commands that require a parameter, the parameter for the command is provided in a field 93. Since the purpose of the command 92 is to affect the operation of the tag 12, a discussion of specific commands will be deferred until after the tag 12 has been described in more detail.

The tag 12 has a unique identification code, and the container 11 has a unique identification code. If the tag 12 sends the central system 81 a communication containing the unique tag identification code, the unique signpost code most recently received from any signpost, and the unique container identification code for the container 11 on which the tag is currently mounted, the central system can determine the approximate current location of the container and tag. In particular, the signpost code uniquely identifies the particular signpost that sent it, and the central system knows where that signpost is located. Further, as explained above, if the tag 12 has received signpost signals from that signpost, then the tag and the container must have passed within a radius of about 12 feet from that signpost. The unique tag code and the unique container code tell the central system 81 exactly which tag and container passed near the particular signpost.

Referring again to FIG. 1, the system 10 can optionally include a plurality of cellular telephone towers, one of which is shown diagrammatically at 97. The cell tower 97 is operatively coupled to the central system 81 through a cellular telephone network 98 of a known type. The cell tower 97, cellular telephone network 98, and wireless signals 99 are optional, and are therefore shown in broken lines in FIG. 1. Wireless signals 99 are transmitted in both directions between the tag 12 and the cellular telephone tower 97, using a known cellular telephone network communication protocol. In the disclosed embodiment, the protocol conforms to the General Packet Radio Service (GPRS) communication protocol. The GPRS protocol is a packet-oriented data service available to users of the Global System for Mobile communications (GSM). Alternatively, however, any other suitable cellular communication protocol could be used. The link between the central system 81 and the cellular telephone network 98 can optionally include a conventional Internet protocol (IP) network, such as a portion of the Internet. FIG. 1 depicts the tag 12 as having the capability to both send and receive wireless signals at 99. Alternatively, however, it would be possible to configure the tag so that it can transmit but not receive wireless signals at 99.

The system 10 includes a Global Positioning System (GPS) satellite 101. The satellite 101 is an existing device that is in orbit about the earth. There are actually a plurality of satellites 101 but, for clarity, only one satellite 101 is shown in FIG. 1. The satellite 101 transmits GPS wireless signals 102 that contain positioning information, and that can be received by the tag 12. The tag 12 can take positioning information in signals received from several GPS satellites 101, and then calculate in a known manner the current position of the tag 12 on the surface of the earth. Alternatively, the tag could take the positioning information received from several GPS satellites, and forward this positioning information to the central system 81, for example through the reader 83. The central system 81 could then calculate the current position of the tag 12 on the surface of the earth.

The system 10 further includes a portable handheld unit 106 with a display 107, a manually operable keypad 108, and a cable 111. The cable 111 has at its outer end an electrical connector that can be releasably electrically coupled to a connector on the tag 12. In addition, the tag 12 and the handheld unit 106 can exchange wireless signals, as indicated diagrammatically at 112. In the disclosed embodiment, the wireless signals 112 are UHF signals at the above-mentioned frequency of 433.92 MHz, but they could alternatively use any other suitable frequency.

The system 10 has an antenna 116 that is coupled to the central system 81, in order to permit the central system 81 to exchange wireless signals 117 with a communication satellite 118. In turn, the communication satellite 118 can exchange wireless signals 119 with the tag 12. In the disclosed embodiment, the wireless signals 117 and 119 conform to a known satellite communication protocol, which is the IEEE L-band protocol. However, it would alternatively be possible for the wireless signals 117 and 119 to conform to some other communication protocol. The link between the central system 81 and the antenna 116 can optionally include a conventional Internet protocol (IP) network, such as a portion of the Internet. FIG. 1 depicts the tag 12 as having the capability to both send and receive wireless signals at 119. Alternatively, however, it would be possible to configure the tag so that it can transmit but not receive wireless signals at 99.

For purposes of this disclosure, when a communication path uses long-range wireless transmissions, for example transmissions capable of traveling distances of about 1 Km or more, that communication path is considered to be a wide area network (WAN). The communication path 99 between the tag 12 and the cell tower 97 is one example of a WAN. The communication path 119 between the tag 12 and the satellite 118 is another example of a WAN. In contrast, for purposes of this disclosure, when a communication path uses short-range wireless transmissions, for example transmissions capable of traveling distances of about 500 m or less, that communication path is considered to be a local area network (LAN). The communication paths 84 and 88 between the tag 12 and the RFID reader 83 and signpost 87 are examples of LANs.

As another example of a LAN, the system 10 could optionally include a LAN 126 in the form of a wireless computer network, which is electrically coupled to the central system 81, and which can communicate with the tag 12 through the transmission and reception of wireless signals 127. The LAN 126 is shown in broken lines in FIG. 1, because it is optional. In the disclosed embodiment, the wireless signals 127 conform to a known wireless computer network communication protocol, which is the IEEE 802.11g communication protocol. However, it would alternatively be possible to use any other suitable wireless computer network communication protocol. Wireless systems and communication protocols of this type are commonly referred to as “Wi-Fi”. FIG. 1 depicts the tag 12 as having the capability to both send and receive wireless signals at 127. Alternatively, however, it would be possible to configure the tag so that it can transmit but not receive wireless signals at 127.

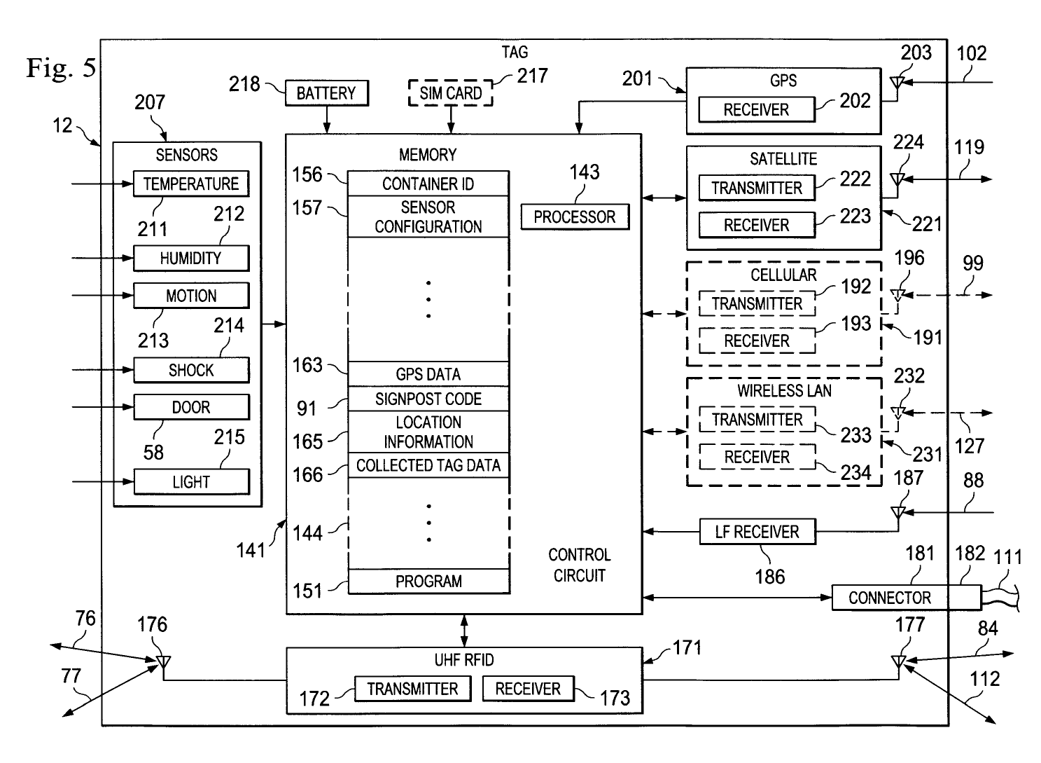

FIG. 5 is a block diagram showing in more detail some internal circuitry of the tag 12. FIG. 5 does not show all internal circuitry of the tag 12, but only portions of the circuitry that are relevant to an understanding of the present invention. The circuitry in tag 12 includes a control circuit 141, and the control circuit includes a processor 143, and a memory 144. The processor 143 is a microprocessor of a known type, and is therefore not illustrated and described here in detail. In the disclosed embodiment, the memory 144 is a diagrammatic representation of the storage available within the control circuit 141, and may include more than one type of memory. For example, the memory 144 may include one or more of read only memory (ROM), random access memory (RAM), flash memory, or any other suitable type of memory.

FIG. 5 diagrammatically shows some of the different types of information stored within the memory 144. In particular, the memory stores a computer program 151 that is executed by the processor 143. The program 151 may be referred to as firmware. The memory also stores a container identification 156, which is a code that uniquely identifies the particular container 11 (FIG. 1) on which the tag 12 happens to be currently mounted. The memory 144 contains sensor configuration information 157, which is explained in more detail later.

The memory 144 stores GPS data 163. In this regard, each time the tag 12 takes a “GPS fix” (by recording positioning information currently being received from GPS satellites), the positioning information is saved at 163. The data saved for each GPS fix includes a time stamp specifying the time and date that the GPS fix was obtained. The memory 144 also stores location information 165, representing the current location of the tag 12 on the surface of the earth. The tag 12 can derive the location information from the GPS positioning information stored at 163.

The central system 81 can provide the tag 12 with some information that can help the tag obtain a GPS fix. For example, with reference to FIG. 1, if the tag 12 happens to be communicating with the central system 81 through the cell tower 97, then the central system 81 knows that the tag is within the area or “cell” serviced by that particular cell tower. Consequently, the central system 81 has a rough idea of the current location of the tag 12. Similarly, if the central system 81 is currently communicating with the tag 12 through the RFID reader 83, then the central system 81 knows that the tag is within the communication range of the reader, and thus has a rough idea of the current location of the tag 12. In either situation, to the extent the central system 81 has a rough idea of the current location of the tag 12, the central system can transmit this information to the tag, for example through the cell tower 97 or the reader 83, and the tag can then save this information. Later, when the tag needs to calculate its precise current position from GPS satellite signals, this information can give the tag a rough initial idea of its current location, and that in turn permits the tag to more rapidly calculate a highly accurate GPS fix indicating its current location on the surface of the earth.

As discussed above in association with FIG. 1, the tag 12 can interrogate other tags 73 and 74 that are located within the container 11, and thus collect information from those other tags. The tag 12 takes this information collected from other tags, and stores it in a section 166 of the memory 144.

The tag 12 includes a UHF transceiver 171 that is coupled to the control circuit 141, and the transceiver includes a transmitter 172 and a receiver 173. As mentioned earlier, the disclosed tag 12 happens to include the UHF transmitter 172, but this transmitter is optional, and could be omitted for some applications, although the receiver 173 would typically still be present. The control circuit 141 can selectively turn the transmitter 172 on and off, and can selectively turn the receiver 173 on and off, in order to reduce overall power consumption. As discussed above, the transmitter 172 and the receiver 173 each operate at 433.92 MHz. The transceiver 171 is coupled to two antennas 176 and 177. The antenna 176 is located in the interior module 56 (FIG. 3), and is used to communicate at 76 and 77 (FIG. 1) with other tags 73 and 74 in the container. The antenna 177 is located in the exterior module 57 (FIG. 3), and is used to communicate at 84 with the reader 83, and at 112 with the handheld unit 106.

The tag 12 has an electrical connector 181 that is part of the exterior module 57 (FIG. 3), that can be accessed from externally of the tag, and that is electrically coupled to the control circuit 141. The cable 111 (FIG. 1) of the handheld unit 106 has at its outer end a connector 182 that can be releasably electrically coupled to the connector 181.

The tag 12 includes a low-frequency (LF) receiver 186 that is coupled to the control circuit 141, and to an antenna 187. The antenna 187 is located in the exterior module 57 (FIG. 3) of the tag. The wireless signals 88 (FIG. 1) from the signpost 87 are received by the tag 12 through the antenna 187 and the receiver 186. The receiver 186 operates at a frequency of 122.88 KHz, as mentioned earlier. The control circuit 141 can selectively turn the LF receiver 186 on and off, in order to reduce power consumption.

The tag 12 could optionally have a cellular transceiver 191 that includes a transmitter 192 and a receiver 193, and that is coupled to the control circuit 141. The transceiver 191 is coupled to an optional antenna 196, where the antenna 196 is located in the exterior module 57 (FIG. 3). The tag 12 can use the transceiver 191 and the antenna 196 to send and receive GPRS wireless signals 99 to and from the cell tower 97 (FIG. 1). The control circuit 141 can selectively and independently turn the transmitter 192 and receiver 193 on and off, in order to reduce power consumption. In FIG. 5, the transceiver 191 is depicted as containing both the transmitter 192 and the receiver 193. Alternatively, however, it would be possible to configure the tag so that it has only the transmitter 192, and not the receiver 193.

The tag 12 has a GPS circuit 201 that includes a receiver 202, and that is coupled to the control circuit 141, and. The GPS circuit 201 is coupled to an antenna 203, and the antenna 203 is located in the exterior module 57 (FIG. 3). GPS signals 102 from the GPS satellite 101 (FIG. 1) are received by the tag 12 through the antenna 203 and the receiver 202. The control circuit 141 can selectively turn the receiver 202 on and off, in order to reduce power consumption.

The tag 12 includes a sensor section 207 having several outputs that are each electrically coupled to a respective input of the control circuit 141. The sensor section 207 includes several sensors, one of which is the door sensor 58 that was discussed earlier in association with FIG. 3. The other sensors include a temperature sensor 211, a humidity sensor 212, a motion sensor 213, a shock sensor 214, and a light sensor 215. These six sensors 58 and 211-215 are merely exemplary. The tag 12 could have a larger or smaller number of sensors, and/or different types of sensors.

The temperature sensor 211, the humidity sensor 212, and the light sensor 215 are all provided in the interior module 56 (FIG. 3). The housing of the interior module 56 has openings (or other some other appropriate structure) that gives these sensors access to the temperature, humidity and light conditions within the interior of the container. In the disclosed embodiment, the motion sensor 213 and shock sensor 214 are also provided within the interior module 56. However, they could alternatively be provided elsewhere, for example in the exterior module 57. The light sensor 215 detects the presence or absence of light within the interior of the container 11. As one aspect of this, if the container doors are closed and locked, then the interior of the container should be dark, and the detection of light within the container may suggest a break-in, or some other form of tampering.

As explained earlier, the memory 144 stores sensor configuration information 157. This configuration information includes an indication of whether each of the sensors in the sensor section 207 is currently enabled or disabled, or in other words whether the control circuit 141 should currently accept or discard data from that sensor. For example, if the container 11 is loaded with fruit, the temperature within the container is likely important, and thus the temperature sensor 211 will probably be enabled. In contrast, if the container 11 is loaded with lumber, temperature may not be an issue, and the temperature sensor 211 may therefore be disabled. The sensor section 207 can be configured so that, when a sensor is disabled, that sensor is powered off in order to conserve battery power.

The sensor configuration information 157 also includes thresholds for some or all of the sensors. For example, if the container 11 is loaded with fruit, the temperature within the container should preferably not be allowed to get too high or too low. A high temperature may cause the fruit to ripen too rapidly and thus spoil, whereas a low temperature may injure the fruit by causing it to freeze. Consequently, the sensor configuration information 157 may include an upper limit value and a lower limit value for the temperature sensor 211. If the actual temperature detected by the temperature sensor 211 goes above the upper limit or below the lower limit, the control circuit 141 would designate this condition as an environmental event that justifies the transmission of a wireless signal containing an alarm.

The sensor configuration information 157 could also optionally include other configuration information relating to the sensors 207. As one example, the sensor configuration information could specify that the door sensor 58 can trigger a tamper event by itself, or alternatively that the door sensor 58 and the light sensor 215 must both detect a problem in order to trigger a tamper event.

If the tag 12 includes the optional cellular transceiver 191, then the tag 12 also includes an optional removable Subscriber Identity Module (SIM) card 217. The SIM card 217 is electrically coupled to the control circuit 141, and is a component of a known type that is commonly used in existing cellular telephones. Within the tag 12, the SIM card 217 facilitates communication between the tag 12 and the cellular network 98 (FIG. 1). For example, the SIM card stores network-specific information used to authenticate and identify the tag to the cellular telephone network 98. The SIM card also stores other information of a known type that facilitates communication between the tag and the cellular telephone network. The cellular service plan for the SIM card 217 is configured to include global roaming capability.

The SIM card 217, if present, is located in the interior module 56 (FIG. 3). When the container doors are closed and locked, a person outside the container 11 does not have access to the interior module 56, thereby making it difficult for any such person to remove and/or replace the SIM card (which would be a form of tampering that could interfere with the intended operation of the tag 12). In fact, for enhanced security in the disclosed tag 12, the interior module 56 is not configured to permit field replacement of the SIM card 217. In order to replace the SIM card, the interior module 56 needs to be disassembled in a manner that corresponds to a service procedure requiring the skill level of a factory technician. This is intended to make it even more difficult for a person to tamper with the tag 12 by removing and/or replacing the SIM card 217.

The tag 12 includes a battery 218 that provides operating power to all of the electrical components within the tag 12. In the disclosed embodiment, the battery 218 is a replaceable lithium battery that is a commercially-available part. However, it would alternatively be possible to use any of a variety of other commercially-available batteries, or a custom battery.

The tag 12 includes a satellite transceiver circuit 221 that is electrically coupled to the control circuit 141 and also to an antenna 224. The transceiver 221 includes a transmitter 222 and a receiver 223. The tag 12 uses the transceiver 221 and the antenna 224 to communicate via the wireless signals 119 with the communication satellite 118 (FIG. 1). The control circuit 141 can selectively and independently turn each of the transmitter 222 and receiver 223 on and off, in order to reduce power consumption. In FIG. 5, the transceiver 221 is depicted as containing both the transmitter 222 and the receiver 223. Alternatively, however, it would be possible to configure the tag so that it has only the transmitter 222, and not the receiver 223.

FIG. 6 is a diagrammatic view of a data format used in signals that can be transmitted by the tag 12 to the central system 81, for example at 119 through the transmitter 222, satellite 118 and antenna 116. This data format includes a tag code 226, which is the unique identification code of the tag 12 that was mentioned earlier. It also includes the unique container identification 156 and location information 165 discussed earlier in association with FIG. 5. If the GPS receiver 202 is enabled and operating, the location information 165 will typically be derived from the positioning information in GPS signals received from GPS satellites. Alternatively, if the GPS receiver is disabled, and if the tag 12 is near and receiving signpost signals from a signpost such as the signpost 87 (FIG. 1), then the location information 165 may include the signpost code 91 (FIG. 4) that was most recently received from any signpost.

In FIG. 6, the tag transmission also includes data 227. This data 227 may include (1) the collected tag data 166 (FIG. 5), (2) the most recent information obtained from the sensors in sensor section 207 (FIG. 5), and/or (3) some other data.

Referring again to FIG. 5, the tag 12 may optionally include a LAN transceiver 231 for a wireless computer network. If present, the transceiver 231 is electrically coupled to the control circuit 141, and to an antenna 232. The transceiver 231 includes a transmitter 233 and a receiver 234. Since the transceiver 231 and the antenna 232 are optional, they are shown in broken lines in FIG. 5. The tag 12 can use the transceiver 231 and the antenna 232 to send and receive the wireless signals 127, and thereby communicate with the wireless LAN 126 (FIG. 1). The control circuit 141 can selectively and independently turn each of the transmitter 233 and receiver 234 on and off, in order to reduce power consumption within the tag 12. In FIG. 5, the transceiver 231 is depicted as containing both the transmitter 232 and the receiver 233. Alternatively, however, it would be possible to configure the tag so that it has only the transmitter 2322, and not the receiver 233.

The tag 12 could include each of the satellite transceiver 221, the cellular network transceiver 191, the wireless LAN transceiver 231 and the UHF transceiver 171. However, for reasons for practicality and economy, the tag 12 of FIG. 5 includes only a subset of these transceivers. In particular, the tag 12 includes the satellite transceiver 191 and the UHF transceiver 171. Alternatively, however, the tag 12 could include all of, or some other subset of, the transceivers 221, 191, 231 and 171, and/or some other suitable transmitter, receiver or transceiver. For example, the tag 12 could have circuitry that transmits and/or receives shortwave radio signals, very high frequency (VHF) radio signals, or LORAN (Long Range Aid to Navigation) signals.

In addition to or in place of the UHF transceiver 171 and antenna 177, the tag 12 could have not-illustrated passive or semi-passive circuitry of a type known in the art. In response to an incoming UHF signal 84, the passive or semi-passive circuitry would use a portion of the energy of that signal to provide itself with operating power. Remaining energy from the signal would be reflected or re-transmitted, and the passive or semi-passive circuitry would modulate that reflected or retransmitted energy so as to add information, such as the unique identification code of the tag 12.

Due to the fact that the GPS receiver 202 and the satellite transceiver 221 each transmit and/or receive long-range signals, they consume substantially more power from the battery 218 than short-range transmitters and receivers such as the transceiver 171 (FIG. 5) and the LF receiver 186. For example, Table 1 provides a comparison of typical and maximum power consumption characteristics for these long-range and short-range components.

TABLE 1

| | Transmit | | Receive | | Duty |
|---|---|---|---|---|---|
| | Typical | Maximum | Typical | Maximum | Cycle |
| | (mW) | (mW) | (mW) | (mW) | (ms) |
| Satellite | 1500 | 1500 | — | — | ≈1300 |
| Transmitter | | | | | |
| 222 | | | | | |
| GPS | — | — | 100 | 200 | ≈45000 |
| Receiver | | | | | |
| 202 | | | | | |
| UHF RFID | 60 | 60 | 60 | 60 | ≈100 |
| Transceiver | | | | | |
| 171 | | | | | |
| LF | — | — | >1 | <20 | ≈250 |
| Receiver | | | | | |
| 186 | | | | | |

As discussed above in association with FIG. 4, each of the signpost signals 88 can include a command 92, as well as a parameter 93 for commands that require a parameter. Some examples of different commands will now be discussed. As one example, the command 92 can instruct the tag 12 to turn on its GPS receiver 202 (FIG. 5), or to turn off the GPS receiver. As another example, the command 92 can instruct the tag 12 to turn on its satellite transceiver 221 (FIG. 5), or to turn off the satellite transceiver. As another example, if the cellular transceiver 191 (FIG. 5) is present, the command 92 can instruct the tag 12 to turn on the cellular transceiver, or to turn off the cellular transceiver.

Another example is that the command 92 can instruct the tag 12 to change the rate at which the tag takes periodic GPS fixes. In other words, the tag would increase or decrease the time interval between successive GPS fixes. The parameter 93 would specify the new time interval. Still another example is that the command 92 can instruct the tag 12 to change the rate at which the tag makes WAN transmissions using the satellite transceiver 221 or the cellular transceiver 191. In other words, the tag would increase or decrease the time interval between successive WAN transmissions. The parameter 93 would specify the new time interval.

Yet another example is that the command 92 (FIG. 4) could instruct the tag 12 to replace the sensor configuration information 157 (FIG. 5) with new sensor configuration information that is sent to the tag as the parameter 93. The new sensor configuration information could enable or disable certain sensors, or change the rate at which the tag reads data from any specified sensor. As discussed above, the sensor configuration information 157 can include thresholds for at least some of the sensors. For example, the sensor configuration information can include a high threshold and a low threshold for the temperature sensor 211. The new sensor configuration information provided to the tag can include new threshold values. New thresholds can in turn alter the alarm behavior of the tag. For example, if the maximum and minimum temperature thresholds are changed, this will in turn change the temperatures at which the tag generates an alarm indicating that the measured temperature went above the maximum threshold or below the minimum threshold.

Another example is that the command 92 can instruct the tag to use a different data template for the information that the tag transmits to the central system 81 (FIG. 1). For example, with reference to FIG. 6, and as discussed earlier, a transmission from the tag to the central system can include data 227. The command 92 can instruct the tag (1) that the collected tag data 166 (FIG. 5) is to be included in or excluded from the data 227, (2) that the current readings from sensors in the sensor section 207 are to be included in or excluded from the data 227, and so forth. Yet another example is that the command 92 can instruct the tag to save certain specified data, and then later transmit it at 227 to the central system 81.

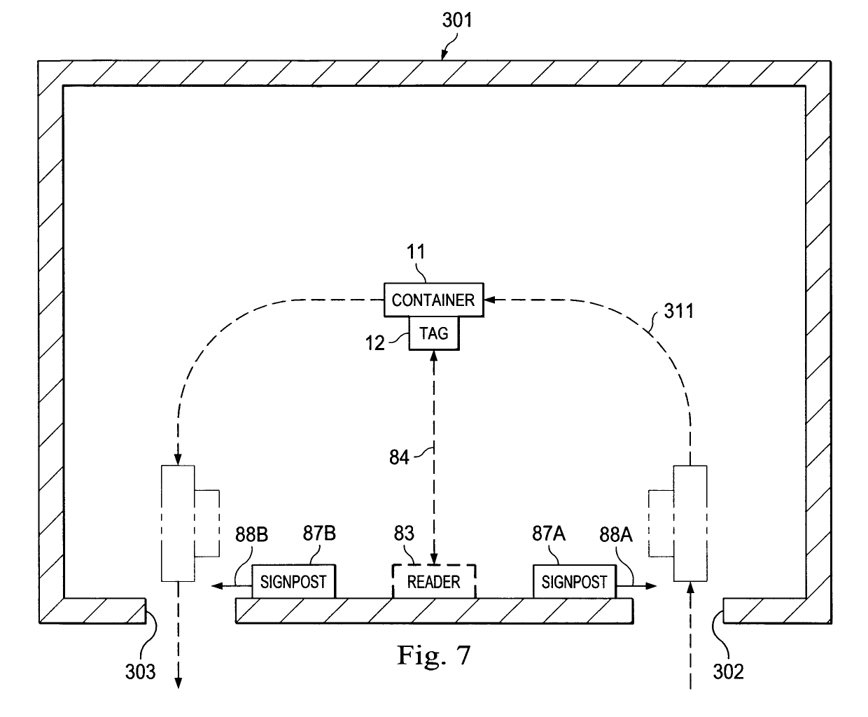

FIG. 7 is a diagrammatic sectional top view of a warehouse 301 through which the container 11 and tag 12 may travel. The warehouse 301 has two spaced doorways 302 and 303. The doorway 302 is used as an entrance, and the doorway 303 is used as an exit. A signpost 87A is mounted near the doorway 302, and transmits a signpost signal 88A toward the doorway 302. Another signpost 87B is mounted near the doorway 303, and transmits a signpost signal 88B toward the doorway 303. A reader 83 can optionally be provided within the warehouse 301. The entry doorway 302 with the signpost 87A may be referred to as a “waypoint”, and the exit doorway 303 with the signpost 87B may also be referred to as another waypoint.

For purposes of this discussion, assume that the container 11 and tag 12 follow a path of travel indicated diagrammatically by a broken line 311. More specifically, the container 11 and tag 12 approach and pass through the entry doorway 302, then spend a period of time stored within the warehouse 301, and then exit the warehouse through the exit doorway 303. As the container and tag are moving along the path of travel 311, before they reach the doorway 302, the tag 12 will typically be using its GPS receiver 202 (FIG. 5) to receive GPS signals so that the tag can determine where it is on the surface of the earth. Further, the tag will typically be using the satellite transceiver 221 (FIG. 5) to periodically transmit information via satellite to the central system 81. In addition, the tag will typically be using one or more of the sensors in the sensor section 207 (FIG. 5 to monitor various environmental or other conditions.

When the container 11 and tag 12 are inside the warehouse 301, the GPS receiver 202 and satellite transceiver 221 may be ineffective, or at least exhibit degraded performance. For example, if the warehouse is a steel-frame building, it may act as an electromagnetic shield that blocks or degrades most or all wireless WAN transmissions to or from the tag. Further, if the warehouse 301 has a security system, and/or the interior of the warehouse is climate controlled, then while the tag is within the warehouse, the tag may not need to use all of the sensors in its sensor section 207 to carry out monitoring directed to environmental conditions and security considerations. Accordingly, the GPS receiver 202, the satellite transceiver 221 and/or some or all of the sensors can essentially be disabled while the container 11 and tag 12 are within the warehouse 301, thereby achieving a significant reduction in power consumption that helps to avoid unnecessarily rapid discharging of the battery 218.

With this goal in mind, as the container 11 and tag 12 pass through the entry doorway 302, the tag will receive one or more signpost signals 88A from the signpost 87A. The command or commands 92 (FIG. 4) in these signpost signals will instruct the tag to disable its GPS receiver 202 and/or its satellite transceiver 221. These signpost signals may also contain a command 92 that (1) provides the tag with new sensor configuration information 157, (2) disables one or more sensors in the sensor section 207, and/or (3) changes alarm conditions by modifying thresholds.

When the container 11 and tag 12 later leave the warehouse 301 through the exit doorway 303, the tag will receive one or more signpost signals 88B from the signpost 87B, thereby restoring the tag 12 to the operational state that it had when it arrived. For example, the tag will be instructed to enable its normal use of the GPS receiver 202, satellite transceiver 221, and sensor section 207. As part of this, the sensor configuration information 157 may be restored to the state that it had when the tag arrived at the warehouse 301.

In effect, as the tag 12 enters and exits the warehouse 301, short-range LAN components such as the signposts 87A and 87B reconfigure the tag in regard to its use of long-range WAN components such as the GPS receiver 202 and the satellite transceiver 221. One benefit is reduced power consumption, and thus reduced discharge of the battery 218. This can also reduce service costs associated with WAN components. For example, each transmission from the tag 12 through the satellite 118 (FIG. 1) will typically involve a service charge from the owner/operator of the satellite. Disabling the satellite transceiver 221 while the tag 12 is in the warehouse will reduce the service costs associated with the use of the satellite.

Summarizing, the operation of the tag 12 is dynamically configured in a manner that is intended to minimize power consumption and service charges, while maximizing “visibility” of the tag to the central system 81. Reducing power consumption from the battery 218 can permit use of a smaller battery, thereby reducing the size, cost and weight of the battery 218 and also the tag 12. Further, reducing the size of the battery 218 serves to reduce the volume of chemicals or other hazardous substances that are present in the battery and thus in the tag.

Although FIG. 7 depicts a scenario where the behavior of a tag 12 is altered as it enters and exits a warehouse, the same basic principles can be applied in a variety of other situations where a LAN may be present. For example, assume that the container 11 and tag 12 are on a truck that is moving along a roadway, and the roadway passes through a long tunnel. A LAN within the tunnel could include a signpost at the tunnel entrance that disables WAN, GPS and sensor activity in the tag, and another signpost at the tunnel exit that re-enables this activity.

Although selected embodiments have been illustrated and described in detail, it should be understood that a variety of substitutions and alterations are possible without departing from the spirit and scope of the present invention, as defined by the claims that follow.

What is claimed is:

1. An apparatus comprising a tag having circuitry that includes:
a transmitter section that can transmit long-range wireless first signals that each include an identification portion uniquely identifying said tag, and that each conform to one of a cellular telephone network communication protocol and a satellite communication protocol; and
a receiver section that can receive short-range wireless second signals that each include a command portion, said tag being responsive to said command portion of one said first signal received by said tag for altering the operation of said transmitter section.

2. An apparatus according to claim 1,
wherein said transmitter section has a first operational mode in which said transmitter section transmits said first signals, and a second operational mode in which transmission of said first signals is disabled and said transmitter section consumes less power than in said first operational mode; and
wherein in response to said command portion of said one first signal said tag causes said transmitter section to switch from operation in one of said first and second operational modes to operation in the other thereof.

3. An apparatus according to claim 2, including a further transmitter section that, when said transmitter section for said first signals is in said second operational mode, can transmit short-range wireless third signals that each include said identification portion.

4. An apparatus according to claim 3, wherein said third signals conform to a radio frequency identification (RFID) communication protocol.

5. An apparatus according to claim 1, wherein in response to said command portion of said one first signal said tag causes said transmitter section to alter a rate at which said transmitter section transmits said first signals.

6. An apparatus according to claim 1, wherein in response to said command portion of said one first signal said tag causes said transmitter section to alter a data format used for data transmitted in said first signals.

7. An apparatus according to claim 1, wherein in response to said command portion of said one first signal said tag causes said transmitter section to alter a type of data transmitted in said first signals.

8. An apparatus according to claim 1, wherein said second signals are near field signals of primarily magnetic character.

9. An apparatus according to claim 1, wherein said first signals conform to said satellite communication protocol.

10. An apparatus according to claim 1, wherein said first signals include a location portion containing information relating to a current location of said tag.

11. An apparatus according to claim 10, wherein said tag includes a further receiver section that can receive long-range wireless third signals that contain positioning information, said tag determining said location information as a function of said positioning information.

12. An apparatus according to claim 1, including a system that is separate from said tag, that has an Internet protocol (IP) network, and that receives and transmits through said network information from said first signals.

13. A method of operating a tag having circuitry that includes a transmitter section and a receiver section, comprising:
transmitting with said transmitter section long-range wireless first signals that each include an identification portion uniquely identifying said tag, and that each conform to one of a cellular telephone network communication protocol and a satellite communication protocol;
receiving with said receiver section short-range wireless second signals that each include a command portion; and
responding to said command portion of one said first signal received by said tag by altering the operation of said transmitter section.

14. A method according to claim 13,
wherein said transmitter section has a first operational mode that includes said transmitting of said first signals, and a second operational mode in which said transmitting of said first signals is disabled and said transmitter section consumes less power than in said first operational mode; and
wherein said responding includes switching said transmitter section from one of said first and second operational modes to the other thereof.

15. A method according to claim 13, wherein said altering of the operation of said transmitter section includes one of:
altering a rate at which said first signals are transmitted;
altering a data format used for data transmitted in said first signals; and
altering a type of data transmitted in said first signals.

16. A method according to claim 13, wherein said transmitting is carried out in a manner that includes configuring said first signals to conform to said satellite communication protocol.

17. A method according to claim 13, wherein said transmitting is carried out in a manner that includes configuring said first signals to include a location portion containing information relating to a current location of said tag.

18. A method according to claim 17, including determining said location information as a function of positioning information from long-range wireless third signals received through a further receiver section of said tag.

19. A method according to claim 13, including after said transmitting of said first signals, transmitting information from said first signals through an Internet protocol (IP) network.

20. An apparatus comprising a tag having circuitry that includes:
a first receiver section that can receive long-range wireless first signals containing positioning information, said tag determining, as a function of said positioning information, location information relating to a current location of said tag; and
a second receiver section that can receive short-range wireless second signals that each include a command portion, said tag being responsive to said command portion of one said first signal received by said tag for altering the operation of said first receiver section.

21. An apparatus according to claim 20,
wherein said first receiver section has a first operational mode in which said first receiver section can receive said first signals, and a second operational mode in which reception of said first signals is disabled and said first receiver section consumes less power than in said first operational mode; and
wherein in response to said command portion of said one first signal said tag causes said first receiver section to switch from operation in one of said first and second operational modes to operation in the other thereof.

22. An apparatus according to claim 20, wherein in response to said command portion of said one first signal said tag causes said first receiver section to alter a rate at which said first receiver section receives said first signals.

23. An apparatus according to claim 20, wherein said first signals are satellite transmissions that conform to a satellite transmission protocol.

24. An apparatus according to claim 23, wherein said satellite transmission protocol is the Global Positioning System (GPS) protocol.

25. An apparatus according to claim 20, wherein said second signals are near field signals of primarily magnetic character.

26. An apparatus according to claim 20, including a transmitter section that can transmit long-range wireless third signals that each include an identification portion uniquely identifying said tag, that each include said location information, and that each conform to one of a cellular telephone network communication protocol and a satellite communication protocol.

27. An apparatus according to claim 26, wherein said third signals conform to said satellite communication protocol.

28. An apparatus according to claim 26, including a system that is separate from said tag, that has an Internet protocol (IP) network, and that receives and transmits through said network information from said third signals.

29. A method of operating a tag having circuitry that includes first and second receiver sections that are different, comprising:
receiving with said first receiver section long-range wireless first signals containing positioning information;
determining, as a function of said positioning information, location information relating to a current location of said tag;
receiving with said second receiver section receive short-range wireless second signals that each include a command portion; and
responding to said command portion of one said first signal received by said tag by altering the operation of said first receiver section.

30. A method according to claim 29,
wherein said first receiver section has a first operational mode in which said first receiver section can receive said first signals, and a second operational mode in which reception of said first signals is disabled and said first receiver section consumes less power than in said first operational mode; and
wherein said responding includes switching said first receiver section from operation in one of said first and second operational modes to operation in the other thereof.

31. A method according to claim 29, wherein said altering includes altering a rate at which said first receiver section receives said first signals.

32. A method according to claim 29, including transmitting with a transmitter section of said tag long-range wireless third signals that each include an identification portion uniquely identifying said tag, that each include said location information, and that each conform to one of a cellular telephone network communication protocol and a satellite communication protocol.

33. A method according to claim 32, including after said transmitting of said third signals, transmitting information from said third signals through an Internet protocol (IP) network.

34. An apparatus comprising a tag having circuitry that includes:
a sensor section having a sensor responsive to a condition; and
a receiver section that can receive short-range wireless signals that each include a command portion, said tag being responsive to said command portion of one said wireless signal received by said tag for altering the operation of said sensor section.

35. An apparatus according to claim 34, wherein in response to said command portion of said one wireless signal said tag causes said sensor section to alter a rate at which information regarding said condition is obtained from said sensor.

36. An apparatus according to claim 34, wherein said wireless signals are near field signals of primarily magnetic character.

37. A method of operating a tag having circuitry that includes receiver section and a sensor section having a sensor responsive to a condition, comprising:
receiving with said receiver section short-range wireless signals that each include a command portion; and
responding to said command portion of one said wireless signal received by said tag for altering the operation of said sensor section.

38. A method according to claim 37, wherein said altering of the operation of said sensor section includes altering a rate at which information regarding said condition is obtained from said sensor.
